(19) United States
(12) Patent Application Publication
(10) Pub. No.: US 2007/0171430 A1
(43) Pub. Date: Jul. 26, 2007

(54) SYSTEMS AND METHODS FOR PROVIDING MIRROR TUNNEL MICROPSCOPY

(75) Inventors: Guillermo J. Tearney, Cambridge, MA (US); Brett E. Bouma, Quincy, MA (US); Aydogan Ozcan, Boston, MA (US)

Correspondence Address: DORSEY & WHITNEY LLP;INTELLECTUAL PROPERTY DEPARTMENT, 250 PARK AVENUE, NEW YORK, NY, 10177, US

(73) Assignee: The General Hospital Corporation, Boston, MA (US)

(21) Appl. No.: 11/624,601

(22) Filed: Jan. 18, 2007

Related U.S. Application Data
(60) Provisional application No. 60/760,587, filed on Jan. 20, 2006.

(51) Int. Cl. G01B 11/02

(52) U.S. Cl. 356/512

(57) ABSTRACT

Exemplary apparatus and method for obtaining information associated with at least one image of at least one portion of a sample can be provided. For example, at least one first electro-magnetic radiation can be provided from the at least one portion (e.g., using a first electro-magnetic radiation guiding arrangement which is configured to provide). A plurality of spatial frequency bands of the image associated with the first electro-magnetic radiation can be generated. Further, at least one second electro-magnetic radiation which is associated with the spatial frequency bands of the image can be received (e.g., using a second arrangement), and the image can be reconstructed based on the spatial frequency bands.

### CROSS-REFERENCE TO RELATED APPLICATION(S)

This application is based upon and claims the benefit of priority from U.S. Patent Application Ser. No. 60/760,587, filed on Jan. 20, 2006, the entire disclosure of which is incorporated herein by reference.

### FIELD OF THE INVENTION

The present invention relates generally to mirror tunnel microscopy, and particularly to systems and methods for effectuating mirror tunnel microscopy techniques which can provide reasonably-priced, high speed, wide field-of-view and high resolution optical imaging.

### BACKGROUND INFORMATION

Many applications such as high throughput screening microscopy and telepathology/automated histopathology insist on the use of a digital microscope with a large field of view, high resolution, and rapid acquisition times. Currently, practical implementation of telepathology is limited by the inability to digitally acquire an entire slide for transmission. Several approaches for this task have been implemented, including image tiling (see D. M. Steinberg et al., Diagnostic Cytopathology 25, 389 (2001)), ‘pushbroom’ imaging (see M. B. Sinclair et al., Appl. Opt. 43, 2079 (2004)), and use of multiple miniature microscope objective lenses operating in parallel (see R. S. Weinstein et. al, Human Pathology 35, 1303 (2004)). Indeed, several prior systems have been provided, but are complex, expensive, time consuming (e.g., using ˜15 min/slide), and generally cannot adjust for slide surface non-uniformities without increasing acquisition time significantly (e.g., ˜10 times for a total of approximately 2 hours per slide).

Accordingly, it may be beneficial to address and/or overcome at least some of the deficiencies described herein above.

### OBJECTS AND SUMMARY OF THE INVENTION

The exemplary embodiments of the present invention can overcome the above-described impediments to the MIR imaging, e.g., by utilizing MIR spectral changes in refractive index to obtain chemical information from tissue or biological specimens. For example, exemplary embodiments of systems and methods can be provided for effectuating mirror tunnel microscopy techniques which can provide reasonably-priced, high speed, wide field-of-view and high resolution optical imaging.

According to one exemplary embodiment of the present invention “mirror tunnel microscope” (“MTM”) concepts can be used as for such systems and methods (e.g., imaging systems and methods). MTM techniques may have advantages over the conventional techniques, including possibly rapidly acquiring high-resolution images without a need to use a high pixel-count CCD or a high-NA objective lens. Additionally, the exemplary MTM techniques do not require a translation of the sample or the objective.

According to one exemplary embodiment of the present invention, the exemplary MTM arrangement can use a low numerical aperture (NA) lens together with parallel mirrors positioned between the lens plane and the object plane to provide a relatively simple arrangement for digital wide-field microscopy. With the exemplary embodiment of the MTM system/arrangement, a mirror tunnel can act as a spatial bandpass filter, which may creates low-resolution, bandpassed versions of the object function in the image plane. Each low-resolution image formed by the MTM carries a unique set of spatial frequencies, however. Coherent addition of the spatial frequency information contained in each of these low-resolution images can enhance the overall resolution of the system beyond what can be achieved by the low NA of the lens. Therefore, the mirror tunnel can increases the effective numerical aperture of the lens without degrading its field of view. The length of the mirror tunnel can match the focal length of the low NA lens. Furthermore, the phases (either in spatial Fourier domain or image domain) of each low-resolution image may be recovered.

Foe example, it is possible to use a 4-mirror tunnel, and thus the exemplary embodiment of the MTM system/arrangement can be scalable to enable wide-field (e.g., 2.0×4.0 cm) imaging of microscope slides at, e.g., <1.0 μm resolution. Since each exemplary MTM low-resolution image can be digitized using CCD or CMOS cameras with a relatively small number of pixels, the cost of a full-slide MTM scanner can in principle be low, and high frame rates may be possible.

Thus, exemplary apparatus and method for obtaining information associated with at least one image of at least one portion of a sample can be provided. For example, at least one first electro-magnetic radiation can be provided from the at least one portion (e.g., using a first electro-magnetic radiation guiding arrangement which is configured to provide). A plurality of spatial frequency bands of the image associated with the first electro-magnetic radiation can be generated. Further, at least one second electro-magnetic radiation which is associated with the spatial frequency bands of the image can be received (e.g., using a second arrangement), and the image can be reconstructed based on the spatial frequency bands.

According to another exemplary embodiment of the present invention, the first arrangement can include an optical waveguide arrangement, which may be a mirror tunnel arrangement. The first arrangement and/or the second arrangement can include a lens arrangement, which in turn can include a lens array and/or a plurality of lenses. The second arrangement can include an image recording arrangement configured to record information associated with each of the spatial frequency bands.

The information may include a magnitude of the first electro-magnetic radiation associated with each of the spatial frequency bands. Further, the information can include a phase of the first electro-magnetic radiation associated with each of the spatial frequency bands. The phase can be measured by an interferometry, a tilting an input beam prior to entry to the first arrangement, an estimation of a magnitude of the at least one image, a solution of a transport intensity equation, and/or a removal of the phase. The phase can also be measured by a minimum phase function phase recovery, a self interferometry, and/or a iterative phase recovery from magnitude measurements.

The recording arrangement may include a charged coupled device array, CMOS array, a moving detector arrangement and/or a photo-diode array. A third arrangement can be provided which may be configured to direct the first electro-magnetic radiation associated with each of the spatial frequency bands toward the recording arrangement. The third arrangement can be an electro-magnetic deflector arrangement. The second arrangement may include a further arrangement which may be configured to direct the first electro-magnetic radiation associated with each of the spatial frequency bands toward the recording arrangement. The recording arrangement can include a plurality of detectors and/or a plurality of detector arrays.

According to still another exemplary embodiment of the present invention, the second arrangement can reconstruct the image based on a combination of magnitude and phase of information associated with the spatial frequency bands. The information associated with the spatial frequency bands may be obtained substantially simultaneously. The second arrangement can be configured to reconstruct the image by (i) magnifying the at least one image, and (ii) optically recombining the image. The first arrangement can include a mirror tunnel, and the image may be magnified using a telescope arrangement positioned within the mirror tunnel.

Other features and advantages of the present invention will become apparent upon reading the following detailed description of embodiments of the invention, when taken in conjunction with the appended claims.

### BRIEF DESCRIPTION OF THE DRAWINGS

Further objects, features and advantages of the present invention will become apparent from the following detailed description taken in conjunction with the accompanying figures showing illustrative embodiments of the present invention, in which:

FIG. 1(a) is a side view of an exemplary embodiment of MTM system according to the present invention;

FIG. 1(b) is a schematic diagram of another exemplary embodiment of the MTM system according to the present invention;

FIG. 2 is exemplary illustrations of experimental and theoretical image intensities corresponding to orders |m|<2 for a 2 mirror MTM;

FIG. 3(a) is an exemplary illustration of a theoretical two-dimensional Fourier transform intensity that the exemplary embodiment of the MTM system passes for the parameters as provided in FIG. 2;

FIG. 3(b) is a plot of a first exemplary recovery result along x and y directions respectively with the intensity and phase of the two-dimensional Fourier transform (“FT”) being available;

FIG. 3(c) is a plot of a second exemplary recovery result along x and y directions respectively with the intensity and phase of the two-dimensional FT being available;

FIG. 3(d) is an exemplary illustration of a measured two-dimensional Fourier transform intensity that the exemplary embodiment of the MTM system passes for the parameters as provided in FIG. 2;

FIG. 3(e) is another plot of the first exemplary experimental recovery result;

FIG. 3(f) is another plot of the second exemplary experimental recovery result;

FIG. 4(a) is a flow diagram of an exemplary embodiment of a recovery method according to the present invention which can use a measurement of the intensity image of each order;

FIG. 4(b) is a flow diagram of an exemplary embodiment of an iterative phase recovery procedure of each order's intensity image.

FIG. 5(a) is a flow diagram of an exemplary embodiment of a phase recovery procedure of the method shown in FIG. 4(a); and

FIG. 5(a) is a flow diagram of an exemplary embodiment of the phase recovery procedure of the method shown in FIG. 4(b).

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF EXEMPLARY EMBODIMENTS

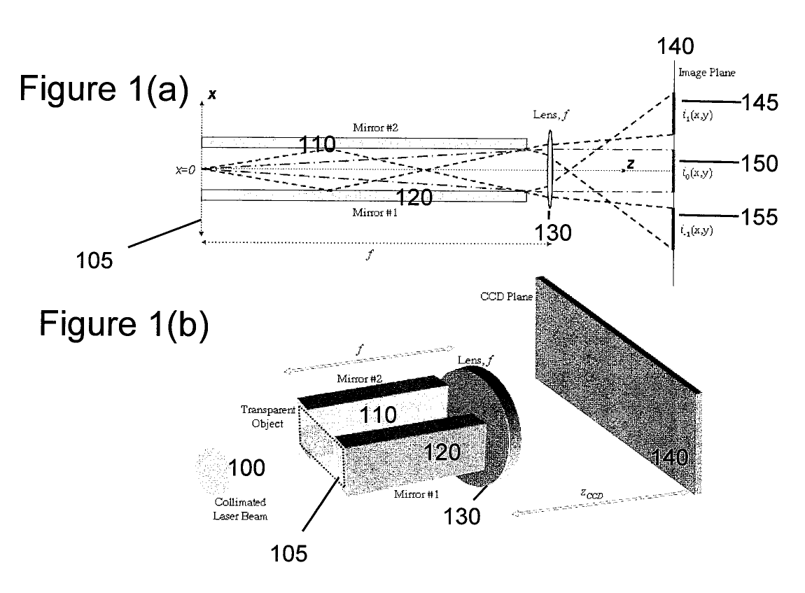

FIG. 1(a) shows a side view of an exemplary embodiment of MTM system according to the present invention. FIG. 1(a) illustrates an exemplary MTM microscope (N=2) that can be used with the exemplary embodiment of the system according to the present invention. For example, an input specimen can be illuminated, and the diffracted light may enter a mirror tunnel 110, 120. An array of virtual images can be imaged onto the output plane be a lens 130. Each successive order (n=0, ±1, ±2 . . . ±N) image contains a bandpassed version of the original image with low-pass cutoff α(n−1) and high-pass cutoff α(n) defined by:

$$α ( n ) = k sin [ {tan}^{- 1} [ \frac{( 2 n + 1 ) d}{2 L} ] ] . \qquad ( 1 )$$

In one exemplary embodiment of the system according to the present invention, the mirror tunnel can act as a device which simultaneously produces multiple-order band-passed versions of the original image at the output plane. Further, some or all frequency components of the original image can be reconstructed by measuring the amplitude and phase of each order image at the output plane. This exemplary operation can be performed in parallel using an array of low numerical aperture lenses and an array of image detectors. Another exemplary embodiment of the arrangement according to the present invention (e.g., a non-parallel implementation) can perform a reconstruction of the image using an arrangement adapted to deflect each order through a low numerical aperture lens onto a single image detector. These exemplary embodiments are advantageous in that the depth of field can be defined by a numerical aperture of the image lens or lenses.

In particular, as shown in FIG. 1(a), the exemplary embodiment of a two-mirror MTM system can include two planar mirrors 110, 120 positioned between a plane of a low NA lens 130 and an object plane 105. In this exemplary configuration, the mirrors 110, 120 (e.g., a mirror tunnel) can act as a spatial periodic-bandpass filter, and may create multiple low resolution bandpassed images (e.g., images 145, 150, 155) of an object function 105, o(x,y), where the x-y plane is perpendicular to the mirror planes, as shown in FIG. 1(a). Each low-resolution image is likely not an exact copy of the object function, but may contain a unique band of spatial frequencies. An image with greater spatial frequency information can therefore be reconstructed by a coherent addition of each of these low-resolution images 145, 150, 155. As a result, the mirror tunnel 110, 120 can increase the effective numerical aperture of the exemplary system without degrading its field of view. For a preferred operation of this exemplary embodiment of the system, a length of the mirror tunnel should roughly match a focal length of the lens 130 as shown in FIG. 1(a).

Each bandpassed image of the exemplary MTM system can be analyzed according to the number of reflections from the mirror walls that occur during the image formation. For example, the 0^{th} order image, i₀(x,y) of the exemplary MTM system can be formed by beams originating from the object 105 o(x,y) that can travel without any reflection from either the left mirror 110 or the right mirror 120 (as shown in FIG. 1(a)). Similarly, the +1^{st}(−1^{st}) order image of the exemplary MTM system can be formed by beams that are reflected once from the right mirror 110 or the left mirror 120 of the exemplary MTM system. Substantially similar naming convention can be used for higher order images. As shown in FIG. 1(a), each image produced by the exemplary MTM system can carry a unique band (or angles) of spatial frequencies. As opposed to self-imaging in fibers and waveguides (described in K. Patorski, “The self-imaging phenomenon and its applications,” Elsevier, Amsterdam, 1989), the lengths of the mirrors 110, 120 of the exemplary MTM system can be substantially smaller, thus making it possible to separate the image orders so that they can be digitized and recombined.

The operation of the exemplary embodiment of a two-mirror MTM system according to the present invention can be mathematically modeled as follows: assuming the two-dimensional FT of the object function 105 o(x,y) can be denoted by O(fₓ, f_{y}), where fₓ and f_{y} are spatial frequencies along x and y, respectively, each low resolution (n-th order) image of the MTM can be written as follows:

$${i}_{n} ( x , y ) = \{ \begin{matrix}{\int }_{{f}_{( 0 ) min}}^{{f}_{( 0 ) max}} {\int }_{- NA / λ}^{NA / λ} O ( {f}_{x} , {f}_{y} ) \cdot exp [ j \cdot 2 π ( {f}_{x} \cdot x + {f}_{y} \cdot y ) ] \cdot d {f}_{y} \cdot d {f}_{x} ; if n = 0 \\ {\int }_{{f}_{( n - 1 ) min}}^{{f}_{( n ) max}} {\int }_{- NA / λ}^{NA / λ} O ( {f}_{x} , {f}_{y} ) \cdot exp [ j \cdot 2 π ( {f}_{x} \cdot x + {f}_{y} \cdot y ) ] \cdot d {f}_{y} \cdot d {f}_{x} ; if n > 0 \\ {\int }_{{f}_{( n ) min}}^{{f}_{( n + 1 ) max}} {\int }_{- NA / λ}^{NA / λ} O ( {f}_{x} , {f}_{y} ) \cdot exp [ j \cdot 2 π ( {f}_{x} \cdot x + {f}_{y} \cdot y ) ] \cdot d {f}_{y} \cdot d {f}_{x} ; if n < 0\end{matrix} \} \qquad ( 1 )$$

where λ is the illumination wavelength, NA is the numerical aperture of the lens 130 in air, and f₍ₙ₎ₘₐₓ and f₍ₙ₎ₘᵢₙ define the spatial frequency boundaries between each order, i.e.,

$${f}_{( n ) max} ( x ) = \frac{1}{λ} \vert sin [ arctan ( \frac{( 2 \vert n \vert + 1 ) \cdot ( d / 2 + L sin α ) - x}{L cos α} ) ] \vert \\ {f}_{( n ) min} ( x ) = - {f}_{( n ) max} ( - x ) = - {f}_{( - n ) max} ( - x ) . \qquad ( 2 )$$

In Eq. 2, d is the gap between the mirrors, L is the length of each mirror and 2α is the full angle between the mirrors. For optimal operation, it is possible to select f≈L cos α and

$$NA \approx sin [ arctan ( \frac{d / 2 + L sin α}{L cos α} ) ] .$$

This exemplary selection can facilitate the MTM to have a large field of view and can still significantly improve the low NA of the exemplary embodiment of the system by a use of the mirror tunnel 110, 120, as shall be described in further detail herein. Further, for a relatively large d with respect to the object function dimensions, the x-dependence in Eq. (2) can be approximately dropped, e.g., to simplify the reconstruction. This exemplary approximation can become more accurate for higher order images (|n|>0).

Using Eqs. (1) and (2), the coherent addition of the higher order image terms can provide an image that can have an increased effective NA along x, i.e.,

$${i}_{R} ( x , y ) = {\int }_{{f}_{( - N ) min}}^{{f}_{( N ) max}} {\int }_{- NA / λ}^{NA / λ} O ( {f}_{x} , {f}_{y} ) \cdot exp [ j \cdot 2 π ( {f}_{x} \cdot x + {f}_{y} \cdot y ) ] \cdot d {f}_{y} \cdot d {f}_{x} , \qquad ( 3 )$$

where the reconstructed image can be provided as

$${i}_{R} ( x , y ) = {\sum }_{m = - N}^{N} {i}_{m} ( x , y ) .$$

In this exemplary reconstruction (see Eq. (3)) the resolution along y can still be limited by the NA of the lens 130, i.e., NA_{y}=NA. However, the effective NA along x, where the two-mirror MTM operates, becomes the following:

$${NA}_{x} = λ \cdot {f}_{( N ) max} \approx \vert sin [ arctan ( \frac{( 2 \vert N \vert + 1 ) \cdot ( d / 2 + L sin α )}{L cos α} ) ] \vert \qquad ( 4 )$$

For α≈0 and f≈L>>d, Eq. (4) can be simplified as NAₓ≈(2|N|+1)·(d/2L). Under the same or similar conditions, NA_{y}=NA≈d/2L. This can be an important result, as possibly implying that by summing over 2N+1 images of the MTM (i.e.,

$${i}_{R} ( x , y ) = {\sum }_{m = - N}^{N} {i}_{m} ( x , y ) ) ,$$

the effective NA along x is also improved 2N+1 times. Moreover, for amplitude transmission objects, i.e., o(x,y)>0, since iₘ(x,y)=i*_{—}_{ₘ}(x,y), where (*) denotes the complex conjugate operation, only N+1 images can be utilized to improve the effective NA by 2N+1 times. For complex transmission objects though, 2N+1 images would still be preferable to enhance the effective NA by 2N+1 times, since in general iₘ(x,y) may be different from i*_{—}_{ₘ}(x,y).

The reconstruction given by Eq. (3) and

$${i}_{R} ( x , y ) = {\sum }_{m = - N}^{N} {i}_{m} ( x , y )$$

utilizes a knowledge of a complex (i.e., phase and amplitude) image of each bandpassed order. The amplitude measurement may be simple, and can use a CCD to obtain the intensities of different orders of the MTM. To achieve the preferred phase recovery, it is possible to use the following exemplary techniques, as well as others:
(a) Spatial interferometry (as described in D. O. Hogenboom et al., Opt. Lett. 23, 783 (1998)), where a Mach-Zehnder interferometer with differently polarized beams can be used to obtain the real and the imaginary parts of the higher order images simultaneously.
(b) Minimum-phase-function based phase recovery (as described in A. Ozcan, “Non-destructive characterization tools based on spectral interferometry and minimum phase functions,” Stanford, Calif., Stanford University; June 2005), where a spatial filter placed at the input end of the mirror tunnel (e.g., facing the object) can artificially convert the effective object function into a two-dimensional (“2D”) minimum-phase function, for which the phase and amplitude of the 2D spatial Fourier transform can be uniquely related through the analytical logarithmic Hilbert transform. This exemplary technique can facilitate a recovery of most or whole complex 2D Fourier transform information from only a measurement of its Fourier intensity.
(c) Self interferometry, where multiple transparent objects (facing each other) are simultaneously imaged in series using two different geometries. (See A. Ozcan, “Non-destructive characterization tools based on spectral interferometry and minimum phase functions,” Stanford, Calif., Stanford University; June 2005; and A. Ozcan et al., Appl. Phys. Lett. 84, 681 (2004)). In this exemplary technique, the difference and the sum of the spatial phases of the two different object functions can be incorporated into magnitude measurements (due to self interference), and the phase recovery of each object function can be achieved just from two intensity measurements.
(d) Estimation (with or without a priori information) from magnitude of image. For example, a subset of this exemplary technique is known as iterative phase recovery from amplitude measurements. (See A. Ozcan, “Non-destructive characterization tools based on spectral interferometry and minimum phase functions,” Stanford, Calif., Stanford University; June 2005; J. R. Fienup et al., J. Opt. Soc. Am. A 3, 1897 (1986); B. C. McCallum et al., J. Modern Opt. 36, 619 (1989); J. R. Fienup et al., J. Opt. Soc. Am. A 7, 450 (1990); J. R. Fienup, Opt. Express 14, 498 (2006); and A. Ozcan et al., Opt. Express 12, 3367 (2004)).

According to one exemplary embodiment of the present invention, an iterative phase recovery technique from intensity measurements is described. Prior to providing a detailed description of the exemplary embodiment of the iterative phase recovery technique, it should be understood that unlike its one-dimensional (“1D”) counterpart, the exemplary solution for an exemplary 2D phase retrieval technique can be unique, and i_{R}(x,y) may converge to a unique o(x,y). (See B. C. McCallum et al., J. Modern Opt. 36, 619 (1989)). The additional exemplary techniques can be as follows:
(e) tilting the input beam, sample, or mirrors and recording simultaneous images (e.g., may be 5-10 times as many images),
(f) solution of the transport intensity equation (as described in A. Barty et. al. Optics Letters 23:1-3, 1998), and/or
(g) removal of the phase (e.g., forcing a symmetric object).

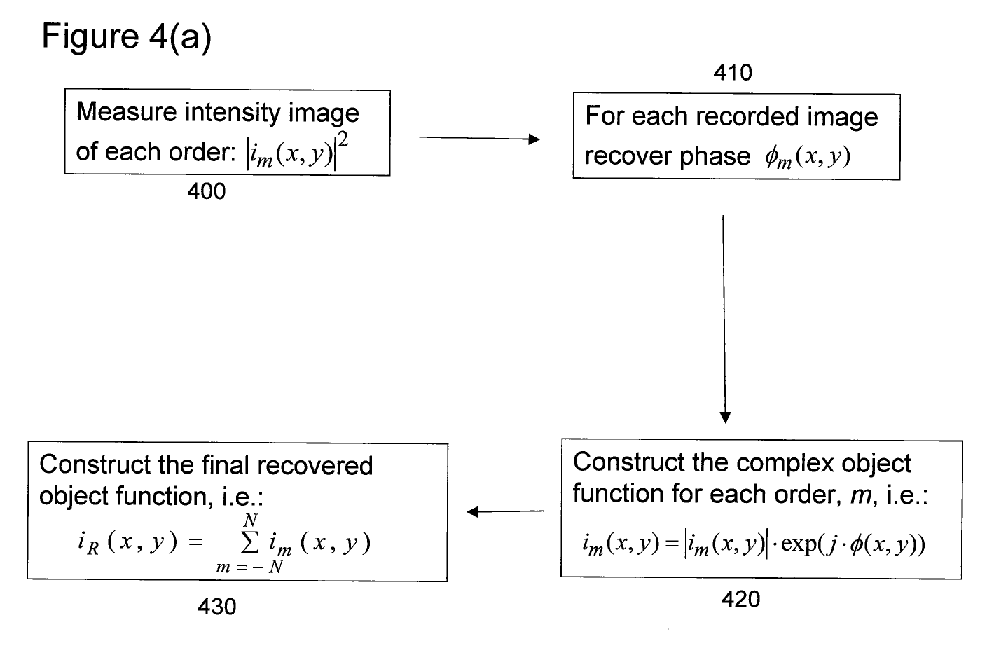

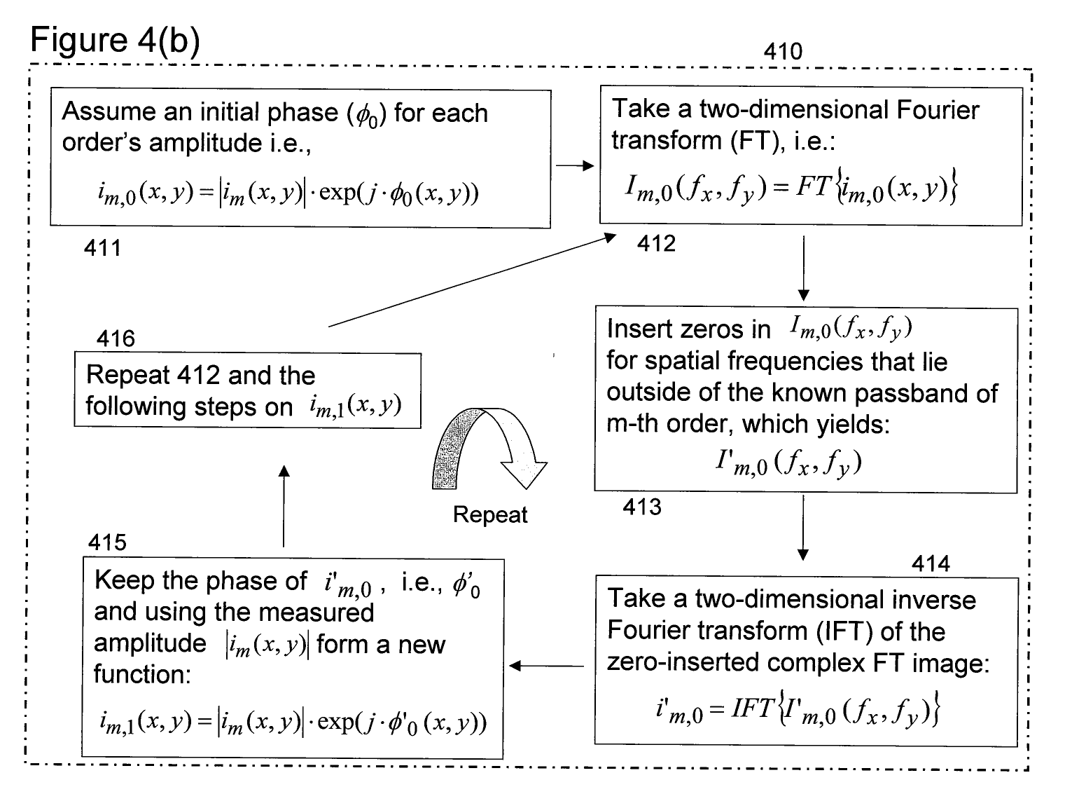

Two different exemplary embodiments of a method according to the present invention can be utilized for the iterative phase recovery technique in MTM. For example, FIG. 4(a) shows a flow diagram of an exemplary embodiment of a recovery method according to the present invention which can use a measurement of the intensity image of each order. First, intensities of each bandpassed image can be measured (step 400), e.g., |iₘ(x,y)|². Exemplary iterative phase recovery techniques (as described in J. R. Fienup et al., J. Opt. Soc. Am. A 3, 1897 (1986); B. C. McCallum et al., J. Modern Opt. 36, 619 (1989); J. R. Fienup et al., J. Opt. Soc. Am. A 7, 450 (1990); and J. R. Fienup, Opt. Express 14, 498 (2006)) can be applied to recover the 2D phase of each image iₘ(x,y), as indicated in step 410.

In particular, FIG. 4(b) shows a flow diagram of an exemplary embodiment of an iterative phase recovery procedure (step 410) of each order's intensity image. For example, in step 411, an initial phase (f0) for each order's amplitude can be assumed, i.e., i_{m,0}(x,y)=|iₘ(x,y)|·exp(j·φ₀(x,y)). Then, in step 412, 2D FT can be obtained, i.e., I_{m,0}(fₓ,f_{y})=FT{i_{m,0}(x,y)}. In step 413, zeros can be inserted in I_{m,0} (fₓ, f_{y}) for spatial frequencies that lie outside of the known passband of m-th order, which can yield I″_{m,0} (fₓ, f_{y}). A 2D inverse Fourier transform (“IFT”) of the zero-inserted complex FT image can be obtained in step 414 as follows: i′_{m,0} (fₓ, f_{y})=IMT{I'_{m,0}(fₓ, f_{y})}. In step 415, the phase of i′_{m,0} (fₓ, f_{y}), i.e., φ′0 is maintained, and using |iₘ(x,y)|, a new function is formed as follows: i_{m,1}(x,y)=|iₘ(x,y)|·exp(j·φ′₀(x,y)). In step 416, the processing is returned to step 412, and performed for i_{m,1}(x,y).

Referring to FIG. 4(a), in step 420, the complex object function for each order, m, can be constructed as follows iₘ(x,y)=|iₘ(x,y)|·exp(j·φ(x,y)). In step 430, the final construct recovery function can be constructed as follows

$${i}_{R} ( x , y ) = {\sum }_{m = - N}^{N} {i}_{m} ( x , y ) .$$

Such iterative approaches can rely on the measurement of |iₘ(x,y)|², with the understanding that the 2D FT of iₘ(x,y) is not an arbitrary FT, but has to lie within the known passband of the m-th order image (step 413 of FIG. 4(b)), as defined by Eq. (1). The known constraint on the width and the location of the FT of iₘ(x,y) with the measurement of |iₘ(x,y)|² can be adequate for a recovery of the phase of iₘ(x,y) (see FIG. 4(b)).

After the exemplary phase recovery procedure, the final higher resolution image can be constructed by coherent addition of the complex images:

$${i}_{R} ( x , y ) = {\sum }_{m = - N}^{N} {i}_{m} ( x , y )$$

(step 430). Depending on the type of the object, the phase recovery steps can be limited to m≧0, since iₘ(x,y)=i*_{—}_{ₘ}(x,y) for amplitude transmission objects. For i₀(x,y), i₀(x,y) is a real quantity (i₀(x,y)=i₀*(x,y)), and therefore the unknown phase at each pixel of |i₀(x,y)| can be either 0 or π, which makes the phase recovery a simpler task. For |m|>0, iₘ(x,y) can become a complex quantity. The exemplary phase recovery procedure in such exemplary case can be more involved, but still achievable.

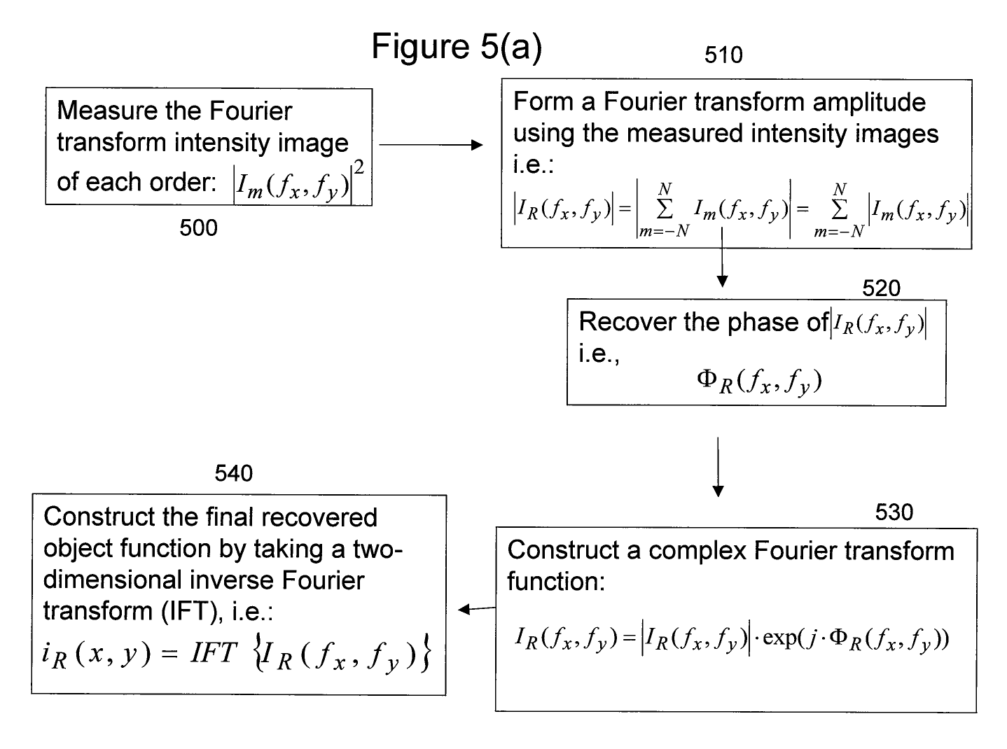

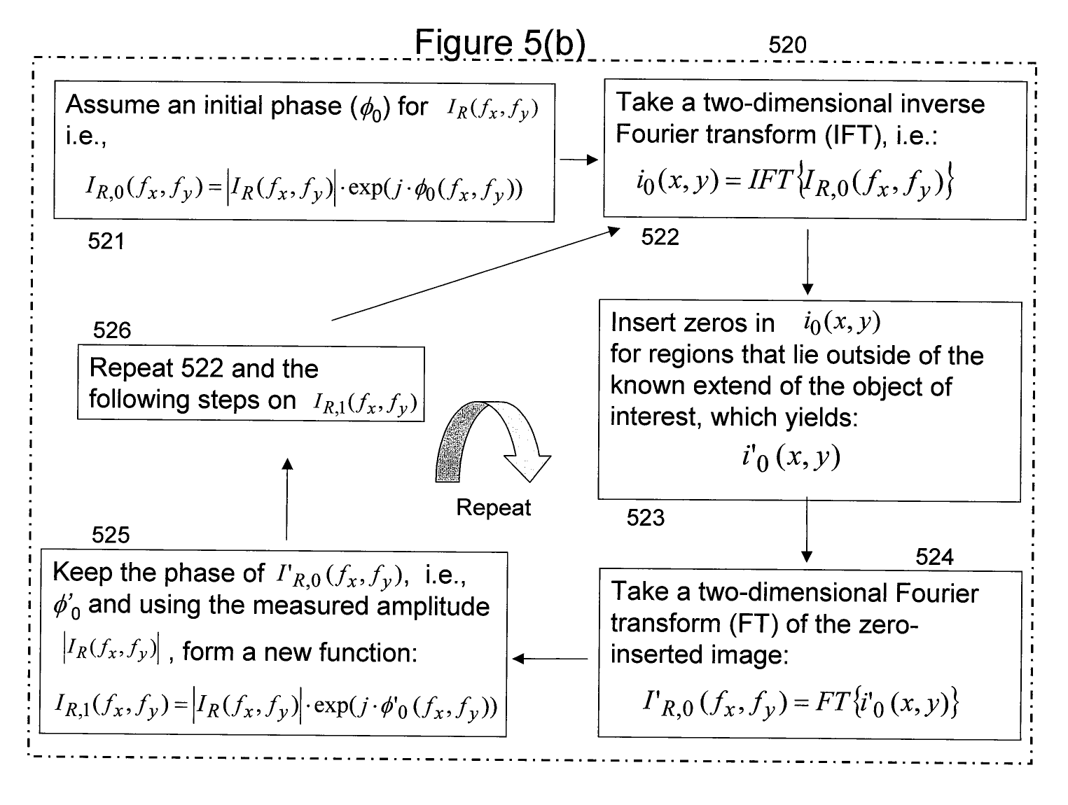

FIG. 5(a) is a flow diagram of an exemplary embodiment of a phase recovery procedure of the method for an iterative phase recovery which can be based on the FT intensity measurements rather than direct measurements of |iₘ(x,y)|² (step 500). In this exemplary embodiment, the FT intensity of each order can be measured using a CCD, e.g., in this exemplary embodiment the measured quantity becomes: |Iₘ(fₓ,f_{y})|², where Iₘ(fₓ,f_{y}) is the 2D FT of iₘ(x,y) (see step 500). Since the passband of each order does not overlap with other orders in the Fourier domain,

$$\vert {I}_{R} ( {f}_{x} , {f}_{y} ) \vert = \vert {\sum }_{m = - N}^{N} {I}_{m} ( {f}_{x} , {f}_{y} ) \vert = {\sum }_{m = - N}^{N} \vert {I}_{m} ( {f}_{x} , {f}_{y} ) \vert$$

can be provided (in step 510), where I_{R}(fₓ,f_{y}) is the 2D FT of

$${i}_{R} ( x , y ) = {\sum }_{m = - N}^{N} {i}_{m} ( x , y ) .$$

As a result, by measuring |Iₘ(fₓ,f_{y})|² corresponding to individual orders of the MTM, it is possible to measure |I_{R}(fₓ,f_{y})|, and the phase recovery can be focused on, e.g., recovering the unknown phase of |I_{R}(fₓ,f_{y})|. In step 530, a complex Fourier transform function can be constructed as follows I_{R}(fₓ,f_{y})=|I_{R}(fₓ,f_{y})|·exp(j·Φ_{R}(fₓ,f_{y})). In step 540, the final recovered object function can be constructed, e.g., by taking a two-dimensional inverse Fourier transform (IFT), i.e., i_{R}(x,y)=IFT{I_{R}(fₓ,f_{y})}.

This exemplary 2D phase recovery problem can also have a particular solution, and the constraints that can be used in the iterative recovery process (step 520) may be as follows: (a) the measured FT intensities, i.e.,

$$\vert {I}_{R} ( {f}_{x} , {f}_{y} ) \vert = {\sum }_{m = - N}^{N} \vert {I}_{m} ( {f}_{x} , {f}_{y} ) \vert ;$$

(b) i_{R}(x,y) may have a finite support, which may be defined by the size of the object; and (c) i_{R}(x,y) is a non-negative real quantity for amplitude transmission objects (see a flow diagram of an exemplary embodiment of the phase recovery procedure 510 as shown in FIG. 5(b) which can be similar to the exemplary steps of FIG. 4(b)). To estimate the finite support of the object function (procedure (b) above) without using the prior information, it is possible to take a 2D inverse FT of the measured |I_{R}(fₓ,f_{y})|², which can yield the auto-correlation function of the object function. The half-widths of the resulting auto-correlation function along both x and y provide an absolute upper bound in space for the object support.

To further improve the speed and the performance of the exemplary recovery procedure, the object support can be better estimated by obtaining a low resolution image of the object, e.g., by recording |i₀(x,y)|² (the 0^{th} order passband image), and using this low resolution image to define a tighter finite support boundary for the recovery algorithm. (See J. R. Fienup et al., J. Opt. Soc. Am. A 7, 450 (1990)). For measuring

$$\vert {I}_{R} ( {f}_{x} , {f}_{y} ) \vert = {\sum }_{m = - N}^{N} \vert {I}_{m} ( {f}_{x} , {f}_{y} ) \vert ,$$

m≧0 can be measured since for an amplitude object |Iₘ(fₓ,f_{y})|=|I_{—}_{ₘ}(−fₓ,−f_{y})|.

According to another exemplary embodiment for achieving the exemplary image recovery results in MTM, it is possible to use an exemplary all-optical reconstruction. For example, this can be done such that all the bandpassed images, iₘ(x,y), may be first magnified by e.g., a telescope configuration positioned within the mirror-tunnel, and then possibly optically recombined (by spatial overlap of all the orders, yielding

$${i}_{R} ( x , y ) = {\sum }_{m = - N}^{N} {i}_{m} ( x , y ) )$$

at the image plane, where e.g., a CCD can obtain the intensity of the optically reconstructed magnified object function. In this exemplary variant, the magnification of the exemplary embodiment of the optical lens system within the MTM system can determine the upper bound of optical resolution (δ) of the MTM, i.e., δ=Δ/M , where Δ is the pixel size of the CCD and M is the magnification of the telescopic system located inside the MTM. For such exemplary all-optical reconstruction to work effectively, different orders of the MTM can be delayed properly (e.g., outside of the MTM) with respect to each other in order to achieve a fully coherent reconstruction. For this exemplary reason, at the exit of the above described magnifying MTM for each order m there need to be a variable delay line, providing the necessary phase shifts of each order, m. One advantage of this approach is speed since computational recovery approaches described above are eliminated at the cost of additional experimental complexity.

Thus, according to still an exemplary embodiment of the present invention, a two-dimensional image may be reconstructed either by using a (N>2) mirror tunnel and applying the above-described exemplary principles and exemplary embodiments of the system according to the present invention. In addition or as an alternative, an N=2 tunnel may be applied, and the tunnel or sample may be rotated in accordance with another exemplary embodiment of the present invention.

### Initial Demonstration Results

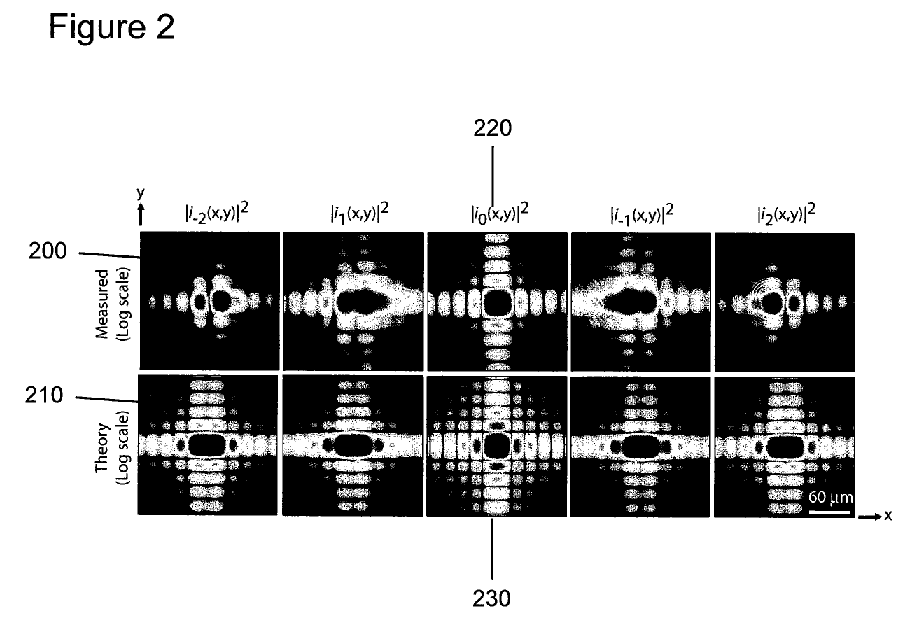

A proof-of-principle of the MTM has been demonstrated by imaging a 20 μm diameter pinhole using a pair of planar mirrors 110 and 120 with L=35 mm, α=0, d=1.2 mm, and an f=50 mm lens 130 with NA˜0.02. The wavelength of operation was λ=633 nm. The imaging was limited to orders |m|≦2. For example, as shown in FIG. 2, the measured image intensities 200, |iₘ(x,y)|², for |m|≦2 were displayed. The theoretical predictions 210 for the MTM image intensities closely resembled the measurement results 200. Thus, FIG. 2 shows the experimental (top row, 200) and theoretical (bottom row, 210) image intensities corresponding to orders |m|<2 for a 2 mirror MTM where L=35 mm, α=0, d=1.2 mm, f=50 mm and NA˜0.02. Indeed, the center measured results 220 and the center theoretical results shows the highest intensity outputs.

For phase recovery, the exemplary FT based iterative technique described above has been implemented. The FT intensities, |Iₘ(fₓ,f_{y}) for m=0, 1 and 2 has been measured. One of the objects was an amplitude transmission object, the FT intensities for m=−1, −2 were not separately required in order to achieve a five-fold (2N+1) improvement in the effective NA. The FT intensity measurement of each order was not taken exactly at the back focal plane of the lens, since there was significant spatial frequency crosstalk between different orders, resulting in frequency aliasing. The physical origin for this effect was the rectangular aperture of the low NA lens, which created ringing in the Fourier plane. To avoid this problem, the FT intensities of each order were recorded at Δz˜40 mm away from the back focal plane of the lens 130, making the undesired crosstalk between each passband negligible. This spatial frequency crosstalk problem could also be mechanically solved by blocking other orders at the exit of the MTM and acquiring the FT intensity of each order sequentially. Measuring the FT intensities away from the focal plane of the lens adds a known quadratic phase term to the recovered object function, i.e.,

$$exp ( j \frac{π}{λ {f}^{′}} [ {x}^{2} + {y}^{2} ] ) ,$$

where f′=f·(f+Δz)/Δz. The reconstructed object function therefore becomes

$${i}_{R} ( x , y ) \cdot exp ( j \frac{π}{λ {f}^{′}} [ {x}^{2} + {y}^{2} ] ) .$$

For amplitude transmission objects this additional phase term does not affect the reconstruction. For phase objects, knowledge of Δz is preferred to recover the original phase of i_{R}(x,y) or o(xy). For small-scale objects, the added phase term across the region of interest becomes negligible. For example, for Δz˜40 mm, only beyond the border of a circular spot with a diameter of ˜100 μm, the added quadratic phase term reaches to ˜0.1 radians.

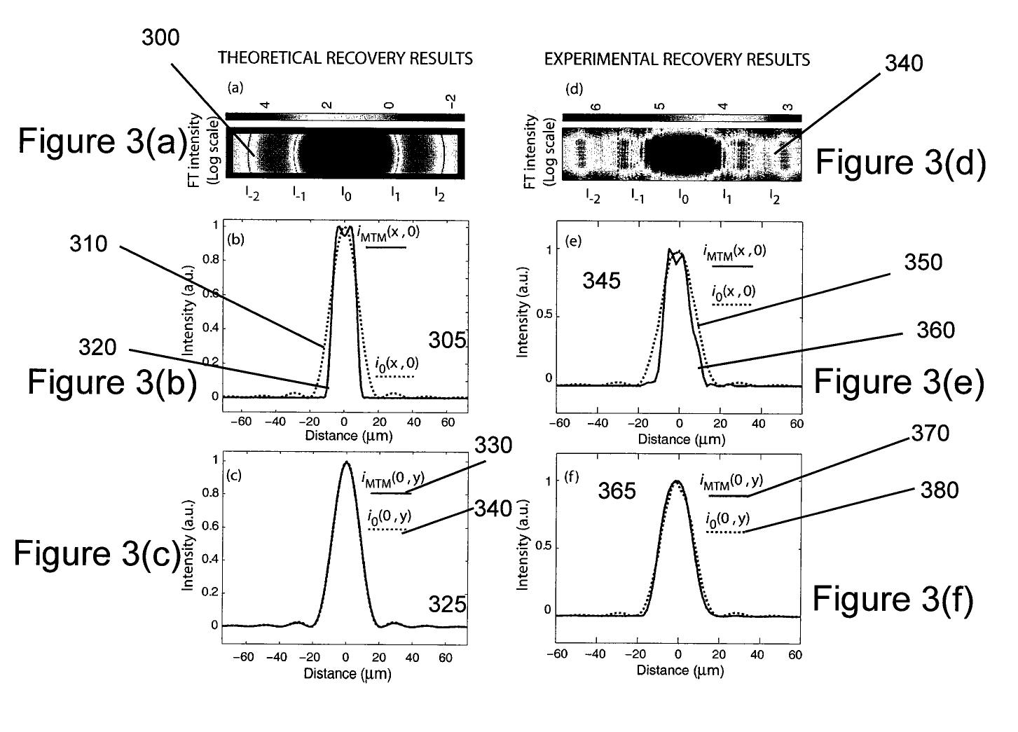

FIG. 3(a) shows the theoretical 2D Fourier transform intensity 300 that the exemplary MTM passes for the same parameters as provided for in the images of FIG. 2.

FIG. 3(d) shows the results for the FT intensity measurement (e.g., a measured 2D Fourier transform intensity) 340, and the boundaries between different orders in the Fourier domain are marked with a gray dotted line. Using the exemplary FT based iterative phase recovery procedure described above, it is possible to recover the most or the entire complex FT: I_{R}(fₓ,f_{y}) For this recovery procedure, it is possible to use ˜500 iterations, after which a 2D inverse FT was taken to recover the object function. Note that except |i₀(x,y)|², the other higher order images of FIG. 2 were not used for the recovery process. As discussed above, |i₀(x,y)|² was used only to estimate a tighter support constraint for i_{R}(x,y) in the iterations.

The experimental recovery results of the MTM are shown in FIGS. 3(e) and 3(f). In particular, FIGS. 3(e) and 3(f) show such recovery results (345, 365), along x and y directions respectively. To illustrate the relative improvement of the mirror tunnel, intensities of i₀(x,0) and i₀(0,y) are also shown in each of FIGS. 3(e) and 3(f) with dotted curves. FIGS. 3(b) and 3(c) show exemplary graphs of the recovery results (305, 325) using the same or similar parameters, along x and y directions respectively, assuming that both the intensity and phase of the 2D FT are readily available. The exemplary results indicate that the 0-th order intensity profile along both x and y approximates a Gaussian curve with some sideband ringing, especially visible between 20 μm and 40 μm (see the dotted curves in FIGS. 3(b)-(c) and FIGS. 3(e)-(f) for theoretical and experimental results, respectively). The overall agreement between the experimental recovery results (340, 345 and 365 of FIGS. 3(d)-3(f)) and the theoretical results (300, 305 and 325 of FIGS. (3(a)-3(c)) are positive; as a result of the 5 fold improvement in NAₓ, the recovery of the diameter of the pinhole (e.g., which can be defined as the full width where the normalized intensity of the image is greater than 10%) may be improved along the x direction by a factor of ˜1.56 and ˜1.43, for the theoretical and experimental results respectively. Furthermore, the experimental results show that the ringing observed in the 0-th order image (e.g., between 20 μm<|x|<40 μm) has also been eliminated.

The foregoing merely illustrates the principles of the invention. Various modifications and alterations to the described embodiments will be apparent to those skilled in the art in view of the teachings herein. Indeed, the arrangements, systems and methods according to the exemplary embodiments of the present invention can be used with and/or implement any OCT system, OFDI system, SD-OCT system or other imaging systems, and for example with those described in International Patent Application PCT/US2004/029148, filed Sep. 8, 2004, U.S. patent application Ser. No. 11/266,779, filed Nov. 2, 2005, and U.S. patent application Ser. No. 10/501,276, filed Jul. 9, 2004, the disclosures of which are incorporated by reference herein in their entireties. It will thus be appreciated that those skilled in the art will be able to devise numerous systems, arrangements and methods which, although not explicitly shown or described herein, embody the principles of the invention and are thus within the spirit and scope of the present invention. In addition, to the extent that the prior art knowledge has not been explicitly incorporated by reference herein above, it is explicitly being incorporated herein in its entirety. All publications referenced herein above are incorporated herein by reference in their entireties.

What is claimed is:

1. An apparatus for obtaining information associated with at least one image of at least one portion of a sample, comprising:
a first electro-magnetic radiation guiding arrangement which is configured to provide at least one first electro-magnetic radiation from the at least one portion, wherein the first arrangement is configured to generate a plurality of spatial frequency bands of the at least one image associated with the at least one first electro-magnetic radiation; and
a second arrangement which is configured to received at least one second electro-magnetic radiation which is associated with the spatial frequency bands of the at least one image, and reconstructs the at least one image based on the spatial frequency bands.

2. The apparatus according to claim 1, wherein the first arrangement includes an optical waveguide arrangement.

3. The apparatus according to claim 2, wherein the optical waveguide arrangement is a mirror tunnel arrangement.

4. The apparatus according to claim 1, wherein at least one of the first arrangement or the second arrangement includes a lens arrangement.

5. The apparatus according to claim 4, wherein the lens arrangement includes at least one of a lens array or a plurality of lenses.

6. The apparatus according to claim 1, wherein the second arrangement includes an image recording arrangement configured to record information associated with each of the spatial frequency bands.

7. The apparatus according to claim 6, wherein the information includes a magnitude of the at least one first electro-magnetic radiation associated with each of the spatial frequency bands.

8. The apparatus according to claim 6, wherein the information includes a phase of the at least one first electro-magnetic radiation associated with each of the spatial frequency bands.

9. The apparatus according to claim 6, wherein the phase is measured by at least one of:
i. an interferometry,
ii. a tilting an input beam prior to entry to the first arrangement,
iii. an estimation of a magnitude of the at least one image,
iv. a solution of a transport intensity equation, or
v. a removal of the phase.

10. The apparatus according to claim 6, wherein the phase is measured by at least one of:
i. a minimum phase function phase recovery,
ii. a self interferometry, or
iii. a iterative phase recovery from magnitude measurements.

11. The apparatus according to claim 6, wherein the recording arrangement includes at least one of a charged coupled device array, CMOS array, a moving detector arrangement or a photo-diode array.

12. The apparatus according to claim 6, further comprising a third arrangement which is configured to direct the at least one first electro-magnetic radiation associated with each of the spatial frequency bands toward the recording arrangement.

13. The apparatus according to claim 12, wherein the third arrangement is an electro-magnetic deflector arrangement.

14. The apparatus according to claim 6, wherein the second arrangement includes a third arrangement which is configured to direct the at least one first electro-magnetic radiation associated with each of the spatial frequency bands toward the recording arrangement.

15. The apparatus according to claim 6, wherein the recording arrangement includes at least one of a plurality of detectors or a plurality of detector arrays.

16. The apparatus according to claim 1, wherein the second arrangement reconstructs the at least one image based on a combination of magnitude and phase of information associated with the spatial frequency bands.

17. The apparatus according to claim 16, wherein the information associated with the spatial frequency bands is obtained substantially simultaneously.

18. The apparatus according to claim 1, wherein the second arrangement is configured to reconstruct the at least one image by (i) magnifying the at least one image, and (ii) optically recombining the at least one image.

19. The apparatus according to claim 18, wherein the first arrangement includes a mirror tunnel, and wherein the at least one image is magnified using a telescope arrangement positioned within the mirror tunnel.

20. A method for obtaining information associated with at least one image of at least one portion of a sample, comprising:
provide at least one first electro-magnetic radiation from the at least one portion via a first electro-magnetic radiation guiding arrangement;
generating a plurality of spatial frequency bands of the at least one image associated with the at least one first electro-magnetic radiation;
receiving at least one second electro-magnetic radiation which is associated with the spatial frequency bands of the at least one image; and
reconstructing the at least one image based on the spatial frequency bands.
